(19) United States
(12) Patent Application Publication
(10) Pub. No.: US 2007/0162704 A1
(43) Pub. Date: Jul. 12, 2007

(54) SYSTEM AND METHOD FOR SEARCHING DATA

(75) Inventors: WEI-QING XIAO, Shenzhen (CN); CHUNG-I LEE, Tu-Cheng (TW); CHIEN-FA YEH, Tu-Cheng (TW); LIANG-PU LI, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/563,155

(22) Filed: Nov. 25, 2006

(30) Foreign Application Priority Data
Jan. 6, 2006 (CN) 200610032806.4

(51) Int. Cl. G06F 12/00

(52) U.S. Cl. 711/118

(57) ABSTRACT

The present invention provides a method for searching data. The method includes the steps of: receiving a search request for searching specified data; searching a permanent cache that stores data for the specified data; determining whether the specified data are stored in the permanent cache; searching Web sites for the specified data if the specified data are not stored in the permanent cache; determining whether any specified data are acquired from the Web sites; defining permanent cache criteria for selecting the specified data acquired from the Web sites if the specified data are acquired from the Web sites; determining whether the specified data acquired from the Web sites meet the permanent cache criteria; and storing the specified data into the permanent cache if the specified data meet the permanent cache criteria. A related system is also disclosed.

### BACKGROUND OF THE INVENTION

1. Field of the Invention

The present invention relates to a system and method for searching data.

2. Description of Related Art

In recent years, with the developments of networks continually improving in speed and expanding in coverage, more and more data are provided through the networks. It is convenient for different users to search, exchange, and acquire various kinds of data on different Web sites through the networks. However, some Web sites that provide professional technology data may impose accessibility limitations. For example, a website that provides patent data may restrict users using an identical Internet protocol (IP) address to access it or acquire/download related patents from it only ten times every day. Thus, if an enterprise needs to search newly issued patents of its competitors, the limitations of the website would affect search efficiencies of the enterprise.

Furthermore, different users of the enterprise may need to search same data (i.e., patents, news, or other kinds of data). Such repetitive operations would waste resources of the enterprise.

What is needed, therefore, is a system and method that can help the users to search and acquire specified data quickly, define permanent cache criteria that is used to store specified data acquired from the Web sites in a local storage, and avoid wasting the resources of the enterprise.

### SUMMARY OF THE INVENTION

A system for searching data is provided. The system includes a permanent cache, a defining module, a transmitting module, an executing module, a determining module, and a storing module. The permanent cache is configured for storing data. The transmitting module is configured for receiving search requests. The executing module is configured for searching the permanent cache for specified data according to the search requests, and for searching the Web sites for the specified data if no specified data is stored in the permanent cache, thereby acquiring the specified data if the specified data are available on the Web sites. The defining module is configured for defining permanent cache criteria for selecting the specified data acquired from the Web sites. The determining module is configured for determining whether the specified data acquired from the Web sites meet the permanent cache criteria. The storing module is configured for storing the specified data that meet the permanent cache criteria into the permanent cache.

Furthermore, a method for searching data is provided. The method includes the steps of: receiving a search request for searching specified data; searching a permanent cache that stores data for the specified data; determining whether the specified data are stored in the permanent cache; searching Web sites for the specified data if the specified data are not stored in the permanent cache; determining whether any specified data are acquired from the Web sites; defining permanent cache criteria for selecting the specified data acquired from the Web sites if the specified data are acquired from the Web sites; determining whether the specified data acquired from the Web sites meet the permanent cache criteria; and storing the specified data into the permanent cache if the specified data meet the permanent cache criteria.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of a hardware configuration of a system for searching data in accordance with a preferred embodiment;

FIG. 2 is a schematic diagram of main software function modules of the control server of FIG. 1; and

FIG. 3 is a flowchart of a method for searching data in accordance with a preferred embodiment.

### DETAILED DESCRIPTION OF THE INVENTION

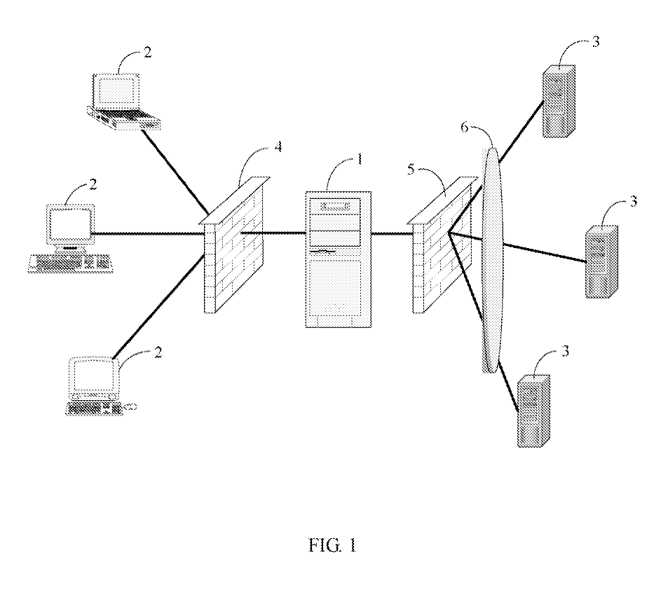

FIG. 1 is a schematic diagram of a hardware configuration of a system for searching data in accordance with a preferred embodiment. The system for searching data (hereinafter, “the system”) includes a control server 1, a plurality of client computers 2, and a plurality of proxy servers 3. The control server 1 is electronically connected with the client computers 2 through a firewall 4. The client computers 2 may be common computer devices, such as personal computers, laptops, portable handheld devices, mobile phones, or other suitable electronic communication terminals. The client computers 2 provide uniform interactive user interfaces, through which, users may input their search requests for searching specified data, and the client computers would correspondingly send the search requests to the control server 1. The control server 1 is further electronically connected with the proxy servers 3 through a firewall 5 via a network 6. The network 6 may be an Ethernet network, a token-ring network, a local area network (LAN), or any other suitable type of communications links. The firewall 4 and the firewall 5 may be of a same type, or of different types.

The firewall 4, the control server 1, and the firewall 5 constitute a demilitarized zone (DMZ) that sits between the local area networks and the Ethernet networks. The DMZ acts as a buffer between a company's local area network and the outside public network (i.e., Internet). Purposes of the DMZ are to secure the company's local area network, and to prevent outside users from getting direct access to a server that has company data.

The proxy servers 3 are configured (i.e., structured and arranged) for linking to Web servers (not shown) that host different Web sites therein via the network 6. The Web sites are sites (locations) on the World Wide Web (WWW), and are entire collections of Web pages and other data (such as images, sounds, and video files, etc.). The Web sites may be specified Web sites, such as patent data Web sites.

The control server 1 is configured for receiving the search requests inputted by different users from the client computers 2, for searching the control server 1 or the Web sites for the specified data by linking to the Web servers via the proxy servers 3, for acquiring the specified data (if available) from the control server 1 locally or from the Web sites remotely, and for returning the specified data as search results to the client computers 2.

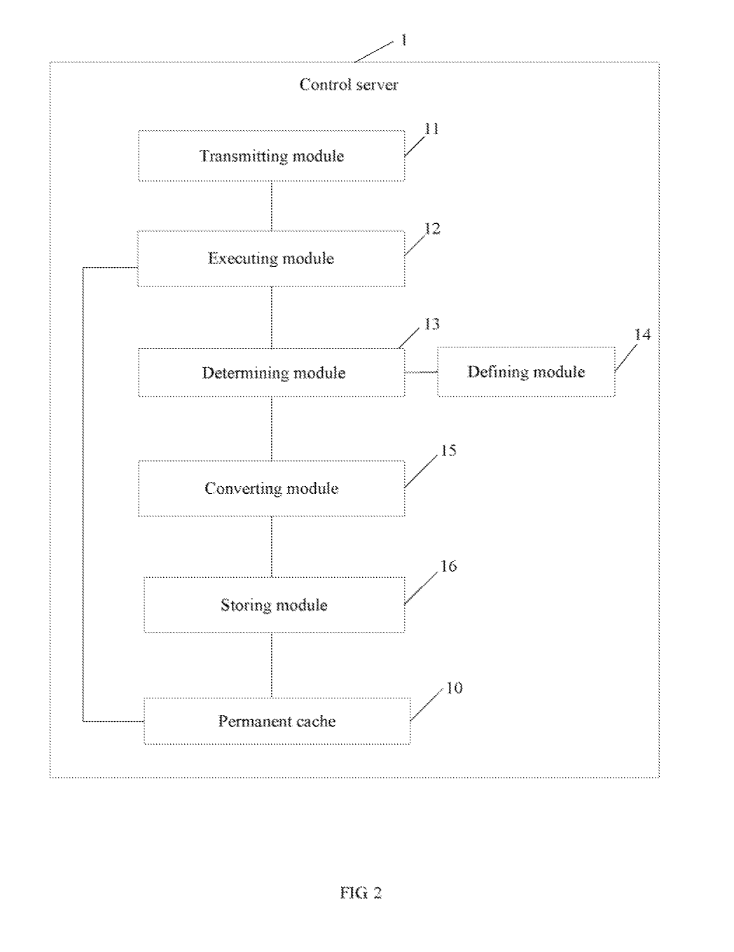

FIG. 2 is a schematic diagram of main software function modules of the control server 1. The control server 1 includes a permanent cache 10, a transmitting module 11, an executing module 12, a determining module 13, a defining module 14, a converting module 15, and a storing module 16.

The permanent cache 10 is configured for storing various data. The permanent cache 10 may be an internal storage of the control server 1, such as a hard disk or a floppy disk, or an external storage of the control server 1, such as a compact disk, a flash memory, or the like. The data stored in the permanent cache 10 may include the Web pages, mirror images of the Web pages, Word™ documents, PDF™ documents, PPT™ (PowerPoint) documents, or other kinds of data. Since the Web pages are updated continually, the corresponding mirror images stored are helpful for the users to collect the specified data.

The transmitting module 11 is configured for receiving the search requests inputted by the users from the client computers 2. The executing module 12 is configured for searching the permanent cache 10 or the Web sites for the specified data according to the search requests, and for acquiring the specified data (if available) from the permanent cache 10 or the Web sites. The transmitting module 11 is further configured for returning the specified data as the search results to the client computers 2. The determining module 13 is configured for determining whether the specified data are stored in the permanent cache 10 or available on the Web sites.

If the specified data are stored in the permanent cache 10, the executing module 12 acquires the specified data, and the transmitting module 11 returns the specified data to the client computers 2. Otherwise, if the specified data are not stored in the permanent cache 10, the executing module 12 is further configured for connecting to the proxy servers 3. Then, the proxy servers 3 link to the Web servers which host different Web sites via the network 6, and the executing module 12 searches the Web sites for the specified data, and acquires the specified data (if available) from the Web sites. The executing module 12 is also configured for replying to the client computers 2 if no specified data are acquired from the Web sites. The replies may include suggestions to change the search requests.

for searching the Web sites for the specified data if no specified data is stored in the permanent cache, thereby acquiring the specified data if the specified data are available on the Web sites

The defining module 14 is configured for defining permanent cache criteria. The permanent cache criteria are configured for filtering the specified data acquired from the Web sites, and for selecting the specified data that meet the permanent cache criteria to store into the permanent cache 10. The permanent cache criteria may be multiple keywords, data types, or some certain Web site addresses, such as names of electronic elements, patent Web sites of different countries, etc. The permanent cache criteria may be modified, and also may be settled. If the permanent cache criteria are settled, the defining module 14 need not to repeat defining the permanent cache criteria frequently while searching the Web sites for different kinds of data.

Generally, the search requests of the users in an enterprise are various, such as a search request for searching patents, a search request for searching industrial data, and a search request for searching sport news, etc. The search results corresponding to the various search requests are not always useful to the enterprise. Thus, the permanent cache criteria are defined for selecting useful data acquired from the Web sites to store into the permanent cache 10, and for filtering useless data. If another user inputs a search request to search the same specified data again, the specified data stored in the permanent cache 10 are returned to the user directly from the permanent cache 10. For example, the defining module 14 defines the permanent cache criteria by defining a Web site address of “http://www.uspto.gov”, thus, all the specified data acquired from the Web site address are allowable to store into the permanent cache 10, and the specified data acquired from the other Web site address are denied.

The defining module 14 is further configured for defining a predetermined format of the data stored in the permanent cache 10. The predetermined format is convenient for the users to structure, store, and search the data stored in the permanent cache 10. For example, the predetermined format may be the extensible markup language (XML) format.

The converting module 15 is configured for converting formats of the specified data acquired from the Web sites into the predetermined format. For example, the executing module 12 acquires the specified data from the Web sites, and the converting module 15 coverts the hypertext markup language (HTML) format of the specified data to the XML format.

The determining module 13 is further configured for determining whether the specified data converted meet the permanent cache criteria. The storing module 16 is configured for storing the specified data converted that meet the permanent cache criteria into the permanent cache 10. The transmitting module 11 is further configured for returning the specified data converted to the client computers 2.

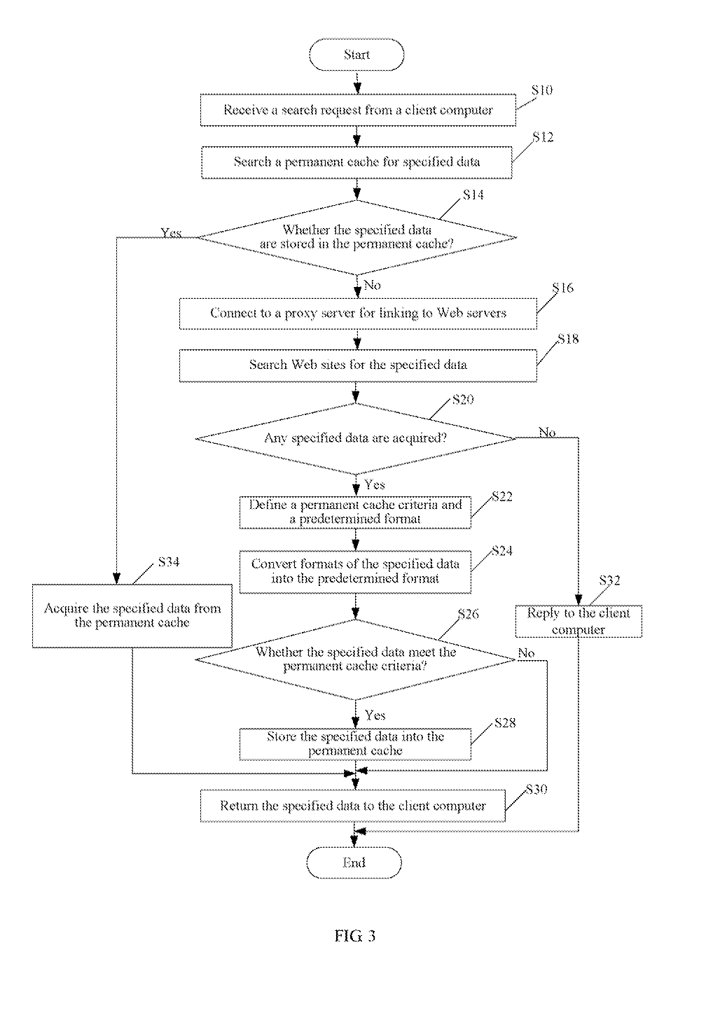

FIG. 3 is a flowchart of a method for searching data. In step S10, the transmitting module receives a search request inputted by the user from one of the client computers 2 for searching the specified data.

In step S12, the executing module 12 searches the permanent cache 10 for the specified data according to the search request. In step S14, the determining module 13 determines whether the specified data are stored in the permanent cache 10. If the specified data are not stored in the permanent cache 10, in step S16, the executing module 12 connects to one of the proxy servers 3, and the proxy server 3 links to the Web servers that hosts selectable specific Web sites via the network 6.

In step S18, the executing module 12 searches the selectable specific Web sites for the specified data. In step S20, the determining module 13 determines whether any specified data are acquired from the Web sites. If the specified data are acquired from the Web sites, in step S22, the defining module 14 defines the permanent cache criteria, and defines the predetermined format of the data stored in the permanent cache 10. The permanent cache criteria may be multiple keywords, data types, or specific Web site addresses, such as names of electronic elements, patent Web sites of different countries, etc. The permanent cache criteria can be modified according to actual requirements, and the permanent cache criteria also may be settled, thus, the defining module 14 need not to repeat defining the permanent cache criteria frequently while searching the Web sites for different kinds of data. If the permanent cache criteria are settled in a first flow, step S22 is not executed in flows for searching other data, and the procedure goes to step S24 directly.

In step S24, the converting module 15 converts the formats of the specified data acquired from the Web sites into the predetermined format. For example, the predetermined format may be the extensible markup language (XML) format.

In step S26, the determining module 13 determines whether the specified data meet the permanent cache criteria. If the specified data meet the permanent cache criteria, in step S28, the storing module 16 stores the specified data into the permanent cache 10. In step S30, the transmitting module 11 returns the specified data to the client computer 2. If the specified data do not meet the permanent cache criteria, the procedure goes directly to step S30.

If the determining module 13 determines that no specified data is acquired from the Web sites, in step S32, the executing module 12 replies to the client computer 2.

If the determining module 13 determines that the specified data are stored in the permanent cache 10, in step S34, the executing module 12 acquires the specified data from the permanent cache 10, and the procedure goes to step S30.

It should be emphasized that the above-described embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for searching data, comprising:
a permanent cache configured for storing data;
a transmitting module configured for receiving search requests;
an executing module configured for searching the permanent cache for specified data according to the search requests, and for searching the Web sites for the specified data if no specified data is stored in the permanent cache, thereby acquiring the specified data if the specified data are available on the Web sites;
a defining module configured for defining permanent cache criteria for selecting the specified data acquired from the Web sites;
a determining module configured for determining whether the specified data acquired from the Web sites meet the permanent cache criteria; and
a storing module configured for storing the specified data that meet the permanent cache criteria into the permanent cache.

2. The system as claimed in claim 1, wherein the defining module is further configured for defining a predetermined format of the data stored in the permanent cache.

3. The system as claimed in claim 2, further comprising a converting module configured for converting formats of the specified data into the predetermined format.

4. The system as claimed in claim 2, wherein the predetermined format is the extensible markup language format.

5. The system as claimed in claim 1, wherein the permanent cache criteria are multiple keywords.

6. The system as claimed in claim 1, wherein the permanent cache criteria are Web site addresses.

7. The system as claimed in claim 1, wherein the permanent cache is further configured for storing Web pages, and mirror images of the Web pages.

8. The system as claimed in claim 1, wherein the transmitting module is further configured for returning the specified data in response to the search requests.

9. A method for searching data, comprising the steps of:
receiving a search request for searching specified data;
searching a permanent cache that stores data for the specified data;
determining whether the specified data are stored in the permanent cache;
searching Web sites for the specified data if the specified data are not stored in the permanent cache;
determining whether any specified data are acquired from the Web sites;
defining permanent cache criteria for selecting the specified data acquired from the Web sites if the specified data are acquired from the Web sites;
determining whether the specified data acquired from the Web sites meet the permanent cache criteria; and
storing the specified data into the permanent cache if the specified data meet the permanent cache criteria.

10. The method according to claim 9, further comprising the steps of:
defining a predetermined format of the data stored in a permanent cache; and
converting formats of the specified data into the predetermined format.

11. The method according to claim 10, wherein the predetermined format is the extensible markup language format.

12. The method according to claim 9, further comprising the step of returning the specified data in response to the search request.

13. The method according to claim 9, further comprising the step of acquiring the specified data from the permanent cache if the specified data are stored in the permanent cache.

14. The method according to claim 9, wherein the permanent cache criteria are multiple keywords.

15. The method according to claim 9, wherein the permanent cache criteria are Web site addresses.

16. The method according to claim 9, further comprising the step of replying in response to the search requests if no specified data is acquired from the Web sites.
